(19) United States
(12) Patent Application Publication
(10) Pub. No.: US 2019/0086313 A1
(43) Pub. Date: Mar. 21, 2019

(54) METHOD AND APPARATUS FOR DETERMINING DIFFUSION PROPERTIES OF A SAMPLE

(71) Applicant: Malvern Panalytical Limited, Malvern, Worcestershire (GB)

(72) Inventors: Seyi LATUNDE-DADA, Malvern, Worcestershire (GB); Oksana LESZCZYSZYN, Malvern, Worcestershire (GB); David GOODALL, Osbaldwick, York (GB)

(73) Assignee: Malvern Panalytical Limited, Malvern, Worcestershire (GB)

(21) Appl. No.: 16/079,735

(22) PCT Filed: Feb. 23, 2017
(86) PCT No.: PCT/EP2017/054250

§ 371 Date: Aug. 24, 2018

(30) Foreign Application Priority Data
Feb. 25, 2016 (EP) 16157467.8

(51) Int. Cl. G01N 13/00; G01N 15/02

(52) U.S. Cl. CPC G01N 13/00; G01N 2015/0038; G01N 2013/003; G01N 15/0205

(57) ABSTRACT

This application discloses a method of using an apparatus comprising a processor to determine a diffusion coefficient (D) of a solute in a solution flowing in a capillary. The method includes obtaining a first signal comprising a plurality of measurements of solute concentration measured at a first measurement location corresponding with a first mean measurement time that is before a full dispersion condition is met; obtaining a second signal comprising a plurality of measurements of solute concentration measured at a second measurement location corresponding with a second mean measurement time that is after the first mean measurement time and before a full dispersion condition is met; calculating an actual front height ratio; a convection front height ratio; and a proportion of the solute that dispersed between the first mean measurement time and the second mean measurement time.

### CROSS-REFERENCE TO RELATED APPLICATIONS

This application is a national stage application under 35 USC 371 of International Application No. PCT/EP2017/054250, filed Feb. 23, 2017, which claims the priority of European Application No. 16157467.8, filed Feb. 25, 2016, the entire contents of which are incorporated herein by reference.

### FIELD OF THE INVENTION

The invention relates to a method of determining diffusion properties of a sample, and more particularly doing so from Taylorgrams.

### BACKGROUND OF THE INVENTION

Taylor dispersion analysis (TDA) is an absolute method for determining the diffusion coefficients, and hence the hydrodynamic radii of molecules. TDA has been used to analyze amino acids, peptides, proteins, small molecules, macromolecules, nanoparticles and biosensors.

Taylor dispersion within a capillary arises as a combination of the spreading due to axial convection which is regulated by molecular diffusion across the capillary radius. Hence, for TDA to be applicable, the measurement time must be long enough for radial diffusion and hence full dispersion to occur and the characteristic Gaussian concentration profiles to develop. This condition is usually expressed with a dimensionless quantity, the dimensionless residence time τₘ, which is the ratio of the mean measurement time to the characteristic time required for a molecule to diffuse across a capillary radius. The dimensionless residence time is a measure of the degree of dispersion and is typically required to be greater than 1.4. This implies that unfeasibly long measurement times are required for TDA to be applicable for large molecules (with small diffusion coefficients).

A dispersion solution that involves fitting the exact dispersion solution and which is applicable at all dispersion times has previously been used to extract the diffusion coefficients from early-time dispersion Taylorgrams (Latunde-Dada, Seyi, et al. “Methodologies for the rapid determination of the diffusion interaction parameter using Taylor dispersion analysis.” Analytical Methods 8.2 (2016): 386-392). This approach, however, requires the location of the transition point between convection and dispersion. A determination of this location is prone to error and in some cases may be obscured by the response of smaller molecules, which may be present and which undergo full dispersion.

### SUMMARY OF THE INVENTION

In accordance with a first aspect of the invention there is provided a method of determining a diffusion coefficient D or hydrodynamic radius of a solute in a solution flowing in a capillary. The method comprises obtaining a first Taylorgram comprising a plurality of measurements of solute concentration measured at a first residence time; obtaining a second Taylorgram comprising a plurality of measurements of solute concentration measured at a second residence time; determining a first front amplitude A₁ of a solute front from the first Taylorgram; determining a second front amplitude A₂ of a solute front from the second Taylorgram; calculating an actual front height ratio A₂/A₁ of the second front amplitude A₂ to the first front amplitude A₁; and deriving a value of the diffusion coefficient or hydrodynamic radius of the solute from the actual front height ratio A₂/A₁.

According to a second aspect, there is provided a method of using an apparatus comprising a processor to determine a diffusion coefficient or hydrodynamic radius of a solute in a solution flowing in a capillary, comprising:

obtaining a first signal, the first signal corresponding to a temporally-resolved distribution of molecular concentration and comprising a plurality of measurements of solute concentration measured at a first measurement location corresponding with a first mean measurement time that is before a full dispersion condition is met;

obtaining a second signal, the second signal corresponding to a temporally-resolved distribution of molecular concentration and comprising a plurality of measurements of solute concentration measured at a second measurement location corresponding with a second mean measurement time that is after the first mean measurement time and before a full dispersion condition is met;

determining a first front amplitude A₁ of a solute front from the first signal, the first front amplitude corresponding to the arrival of fast moving molecules travelling at or near a central streamline at the first measurement location;

determining a second front amplitude A₂ of a solute front from the second signal, the second front amplitude corresponding to the arrival of fast moving molecules travelling at or near a central streamline at the second measurement location;

calculating: an actual front height ratio A₂/A₁ of the second front amplitude A₂ to the first front amplitude A₁; a convection front height ratio h expected for a pure convection regime; and a proportion f of the solute that dispersed between the first mean measurement time and the second mean measurement time, the proportion f calculated using the actual front height ratio A₂/A₁ and the convection front height ratio h;

deriving a value of the diffusion coefficient of the solute from a relationship between the proportion f and the diffusion coefficient, the relationship corresponding with the measurement conditions of the first and second signal.

In some embodiments, the signal may be obtained from a solution that comprises more than one solute component. In such situations, references to a “full dispersion condition” may refer to the least diffusive solute component of the solution.

The first and second Taylorgrams may be obtained by measurement. The first Taylorgram may be obtained at a first position (or distance from an injection location) along the capillary, and the second Taylorgram may be obtained at a second position (or distance from an injection location) along the capillary. For example, the first and second Taylorgrams may both be obtained from the same injection of solute into the capillary.

Such a method may be used to provide a good estimate of the diffusion coefficient or hydrodynamic radius of large molecules (with a low diffusion coefficient), without the long measurement time usually required for TDA measurements.

The step of deriving a value of the diffusion coefficient or hydrodynamic radius may further comprise calculating a convection front height ratio h expected for a pure convection regime. The convection front height ratio h may be calculated from the distance l₁ between the first residence time (or first measurement location) and a point of injection of the solute into the capillary, the distance l₂ between the second residence time (or second measurement location) and the point of injection of the solute into the capillary, and the initial length lᵢₙⱼ of the solute injected into the capillary.

The first measurement location may be at the same position along the capillary as the second measurement location, for instance using the same detector. The difference between the first mean measurement time and the second mean measurement time may be as a result of a difference in the speed with which the solution flows through the capillary during measurement of the first and second signal. Alternatively, a measurement arrangement with a single detector can be configured between the measuring the first signal and the second signal so that a longer length of capillary is provided between an injection location and the second measurement location (compared with the distance between the injection location and the first measurement location during measurement of the first signal).

The convection front height ratio h may be calculated from the time t_{a,1} of arrival of the solute at the first measurement location for the first signal and the time t_{a,2} of arrival of the solute at the second measurement location for the second signal, and the time tᵢₙⱼ over which the solute was injected into the capillary.

The step of deriving a value of the diffusion coefficient may further comprise calculating the proportion f of the solute that dispersed between the first residence time and the second residence time. The proportion f may be calculated using the actual front height ratio A₂/A₁ and the convection front height ratio h.

The step of determining the first front amplitude may comprise determining a first time window during which a solute front is expected to reach the first measurement location, and determining the peak amplitude of the first Taylorgram in the first time window. The step of determining the second front amplitude may comprise determining a second time window during which a solute front is expected to reach the second measurement location, and determining the peak amplitude of the second Taylorgram in the second time window. The first time window or the second time window may be determined using the pressure at which the solute was injected into the capillary and the viscosity of a carrier fluid and/or the solution. The carrier fluid may drive the solution through the capillary.

Such embodiments may be particularly useful where multiple peaks may be recorded in the Taylorgram, for example if dispersion has occurred before the Taylorgram is measured, or if multiple plugs of sample are injected into the capillary. Determining the first and second window limits the likelihood of selecting an incorrect peak as the front.

Some embodiments may further comprise the step of determining a relationship, for example a constant of proportionality a, between a diffusion coefficient and the proportion f of a test sample of known diffusion coefficient. This step may be used, for example, to calibrate a system.

Some embodiments further comprise calculating a hydrodynamic radius of molecules of the solute from the calculated diffusion coefficient. In other embodiments the hydrodynamic radius may be determined more directly from the ratio A₂/A₁ without explicitly determining the diffusion coefficient first. The well-known relationship between hydrodynamic radius and diffusion coefficient can be incorporated into the method, so that it determines the hydrodynamic radius without explicitly determining the diffusion coefficient as an intermediate step.

In some embodiments, the first and/or second Taylorgram may be measured at a time corresponding to a dimensionless residence time τₘ of 1.4 or less. Such short measurement times are usually not possible using conventional TDA.

According to a third aspect of the invention there is provided a method of measuring a diffusion coefficient or hydrodynamic radius of a solute in a solution flowing in a capillary. The method comprises:

providing a solution flowing in a capillary; providing a first detector at a first residence time and a second detector at a second residence time;

injecting a solute at a pressure into the capillary;

detecting a measure of the concentration of the solute at the first residence time using the first detector and obtaining a first Taylorgram from the measurements of the first detector;

detecting a measure of the concentration of the solute at the second residence time using the second detector obtaining a second Taylorgram from the measurements of the second detector; and

determining a diffusion coefficient of the solute using the method of any embodiment of the first aspect.

According to a fourth aspect, there is provided a method of measuring a diffusion coefficient of a solute in a solution flowing in a capillary, comprising:

providing a solution flowing in a capillary;

providing a first detector at a first measurement location and a second detector at a second measurement location;

injecting a solute at a pressure into the capillary;

detecting a measure of the concentration of the solute at the first measurement location using the first detector;

detecting a measure of the concentration of the solute at the second measurement location using the second detector; and

determining a diffusion coefficient of the solute using the method of the second aspect, the first signal obtained from the step of detecting using the first detector and the second signal obtained from the step of detecting using the second detector.

In some embodiments, the measure of concentration of the solute detected by the first and/or second detectors may be the absorption of light of the solute, measured for example using an ultraviolet-visible spectrophotometer. Alternatively the measure of concentration may be determined by measuring the refractive properties of the solute.

In some embodiments, the solute may be injected into the capillary as a slug of solute or as a pulse of solute.

According to a fifth aspect of the invention there is provided an apparatus for determining a diffusion coefficient or hydrodynamic radius of a solute comprising a processor, the apparatus configured to perform a method in accordance with any preceding aspect. The apparatus may further comprise an instrument for performing a Taylor dispersion analysis, so as to obtain a Taylorgram (or the first and second signal by measurement).

The instrument may comprise: a pump; a capillary; a light source; a first detector and a second detector. The pump may be configured to cause fluid flow in the capillary. The capillary may comprise a first window region, adjacent the first detector, and a second window region, adjacent the second detector. The light source may be configured to illuminate the first and second detector through interior of the capillary at the first and second respective window regions. The first and second detectors may be configured to detect the absorbance of fluid in the capillary at the respective first and second windows. In other embodiments the first and second detectors may detect a change in refractive index of the fluid.

In an alternative embodiment the instrument may comprise: a pump; a capillary; a light source; and a detector. The pump may be configured to cause fluid flow in the capillary. The capillary may comprise a first window region, adjacent the detector. The light source may be configured to illuminate the detector through the interior of the capillary at the window region. The detector may be configured to determine a concentration of molecules within the capillary at the window (e.g. based on absorbance, refraction, etc).

### BRIEF DESCRIPTION OF THE DRAWINGS

The invention is described in further detail below by way of example and with reference to the accompanying drawings, in which:

FIG. 1 is a schematic of a method for calculating the diffusion coefficient of a solute;

FIG. 2 is a schematic of an embodiment of calculating the diffusion coefficient;

FIG. 3 is an example Taylorgram for a solute in a pure convection regime;

FIG. 4 is a schematic of an alternative embodiment of calculating the diffusion coefficient;

FIG. 5 is an example of a Taylorgram for a real solute in solution;

FIG. 6 is a schematic of an alternative method for calculating the diffusion coefficient of a solute;

FIG. 7 is a schematic of an embodiment of determining the peaks in the first and second Taylorgrams;

FIG. 8 is a schematic of an apparatus according to an embodiment;

FIG. 9 shows measured Taylorgrams for a solute in a solution;

FIG. 10 shows measured Taylorgrams for a solute in a solution;

FIG. 11 shows the correlation between 1-f and τₘ for the Taylorgrams of FIGS. 9 and 10;

FIG. 12 shows measured Taylorgrams for a solute in a solution;

FIG. 13 shows measured Taylorgrams for a solute in a solution;

FIG. 14 shows the correlation between 1-f and τₘ for the Taylorgrams of FIGS. 12 and 13;

FIG. 15 shows the global correlation for the Taylorgrams of FIGS. 9, 10, 12, and 13;

FIG. 16 shows measured Taylorgrams for a solute in a solution;

FIG. 17 shows measured Taylorgrams for a solute in a solution.

### DETAILED DESCRIPTION OF THE INVENTION

Taylor dispersion is a process by which shear flow is used to enhance the effective diffusivity of a sample. Laminar flow in a capillary results in a variation in flow velocity with radial location. Near the walls, the flow is substantially stationary, and flow velocity is at a maximum at the centre. This results in shearing of the adjacent lamina, which acts to enhance dispersion of a sample.

Taylor dispersion analysis (TDA) can be used to analyse properties of species within a sample. A plug of the sample may be injected into a capillary and subsequently disperse as it traverses along the capillary within a laminar flow regime. The injected plug of the sample may be narrow (having a short duration) this being referred to as a pulse of the sample, resulting in a pulse Taylorgram. Alternatively the injected plug of the sample may be long (i.e. having a longer duration) this may be referred to as a slug of the sample, resulting in a frontal Taylorgram. The degree of dispersion exhibited by the plug is dependent on the diffusivity of the molecules within the plug and can be measured at one or multiple points downstream of the injection site. A concentration detector, responsive to the species of the sample, may be positioned at one or more locations downstream of the injection location. The concentration detector or detectors (e.g. a UV-Visible spectrophotometer) may thereby produce a signal that is proportional to the concentration of the molecules in each cross-section of the flow past the detector. The resultant signal from the detector, typically referred to as a Taylorgram, corresponds to a temporally-resolved distribution of molecular concentration.

In the embodiments described below, a first Taylorgram is measured at a first time (e.g. a first mean measurement time) at a first position along the capillary using a first detector, and a second Taylorgram is subsequently measured at a second time (e.g. a second mean measurement time) at a second position along the capillary using a second detector. The full set of measurements can thus be taken using only one injection of solute into the capillary. However, any embodiment described below may be modified so that the first and second Taylorgrams are taken at the same position along the capillary, using the same detector. In a first run, the solute may be driven along the capillary by a first pressure or at a first speed, so that it reaches the measuring position at a first time, and the first Taylorgram can be taken. In a second run, the solute may be driven along the capillary by a second pressure or at a second speed, so that it reaches the measuring position at a second time, and the second Taylorgram can be taken.

Conventionally, TDA can only be used to determine the diffusion coefficient D of a solute if the solute is fully dispersed. A measure of the dispersion is given by the dimensionless residence time τₘ, defined as

$${τ}_{m} = \frac{{Dt}_{m}}{{r}_{c}^{2}} , \qquad ( Eq . 1 )$$

where D is the diffusion coefficient, r_{c} is the capillary radius, and tₘ is the mean measurement time, which is equivalent to the time it would take a particle travelling at the average flow speed to arrive at the measurement point. A value of τₘ greater than 1.4 is generally used as the condition for full dispersion, and hence for applicability of TDA. For large molecules, however, the typically low value of D means that long measurement times are required to meet this condition.

Referring to FIG. 1, a method 100 for determining a diffusion coefficient D of a solute in a solution flowing in a capillary is illustrated. Method 100 can be used to determine a value for D using measurements taken at early times, before the full dispersion condition is met. Method 100 can therefore reduce the time needed to measure D for large molecules with low diffusion constants.

At step 101 of method 100, a first Taylorgram/signal is obtained by measuring the concentration of the solute at a first position in the capillary (corresponding with a first mean measurement time). At step 102, a second Taylorgram/signal is obtained by measuring the concentration of the solute at a second position in the capillary (corresponding with a second mean measurement time). The Taylorgrams obtained at 101 or 102 may be generated from a slug or pulse injection of solute into the capillary.

Each Taylorgram typically comprises a sharp rise in concentration corresponding to the arrival of the solute front, followed by a long tail. The solute front corresponds to the arrival of fast moving molecules travelling at or near the central streamline at the measurement point.

A first front amplitude A₁ of the solute front is determined from the first Taylorgram at step 103. A second front amplitude A₂ of a solute front from the second Taylorgram is determined at step 104. At step 105, the ratio A₂/A₁ of the second front amplitude A₂ to the first front amplitude A₁ is calculated.

The ratio A₂/A₁ is related to the amount of dispersion experienced by the solute between the first measuring position and the second measuring position. At step 106, this ratio is used to derive a value of the diffusion coefficient of the solute. Once the diffusion coefficient has been calculated, other parameters can be calculated, such as the hydrodynamic radius of the molecules of the solute, which is related to the diffusion coefficient.

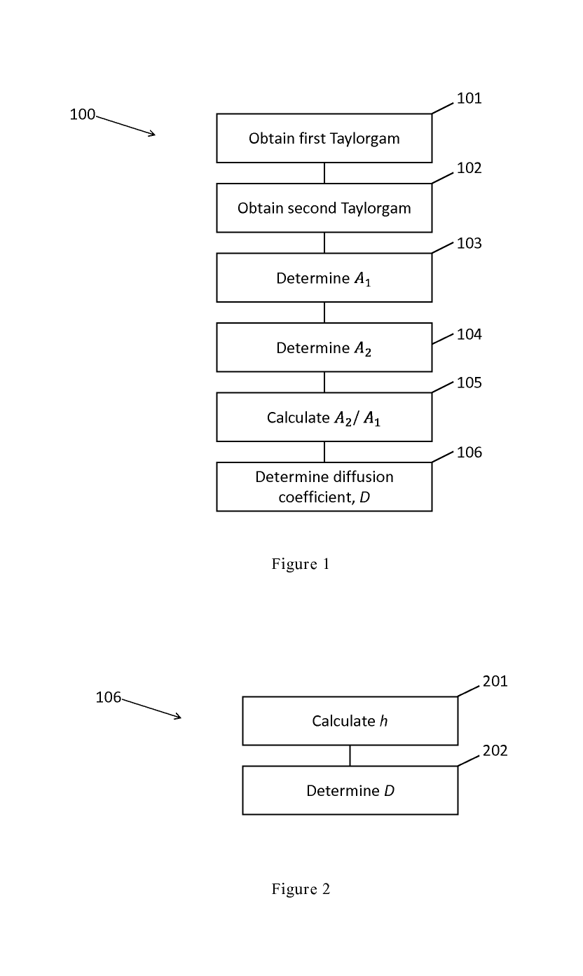

As shown in the embodiment of FIG. 2, the step 106 of method 100 may further comprise step 201 of calculating a convection front height ratio h expected for a pure convection regime—i.e. where there is no dispersion of the solute. A comparison of the actual ratio A₂/A₁ to the convection ratio h is then used at step 202 to calculate the diffusion coefficient D.

The ratio h for the pure convection regime may be calculated by considering the dispersion equation for a short injection of solute for a measurement at time t taken a distance x away from the point of injection:

$$\frac{\partial C}{\partial t} + u \frac{\partial C}{\partial x} = k \frac{{\partial }^{2} C}{\partial {x}^{2}} . \qquad ( Eq . 2 )$$

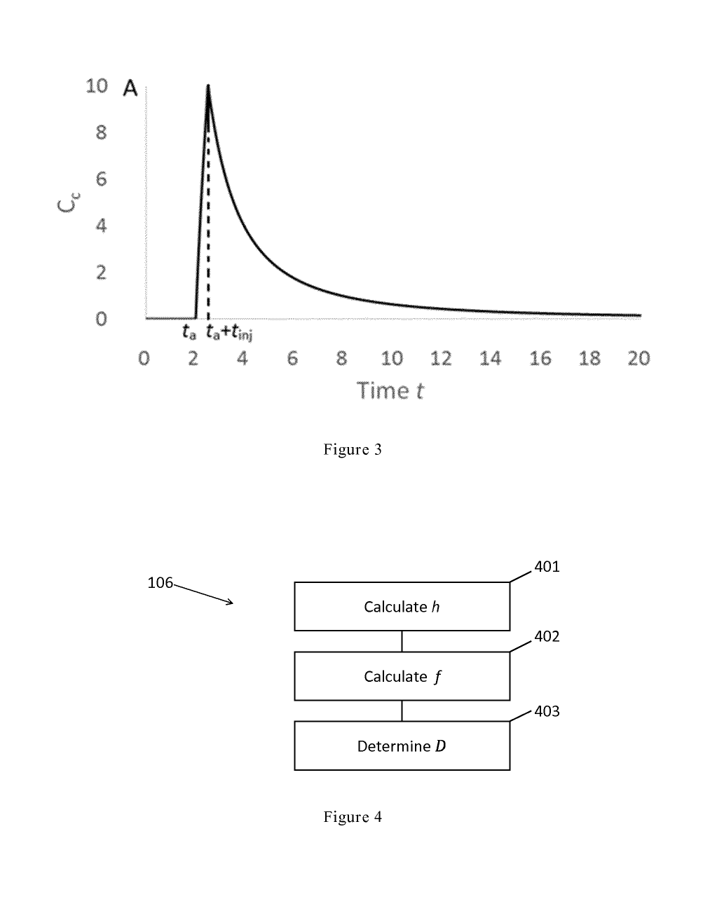

Under pure convection, the diffusion term on the right hand side of Eq. 2 is neglected and the solution obtained for the average concentration distribution C_{C} is:

$$\begin{matrix}{C}_{c} = 0 : ( t \leq \frac{{t}_{m}}{2} ) & \\ {C}_{c} = {C}_{0} [ 1 - \frac{{t}_{m}}{2 t} ] : ( \frac{{t}_{m} + 2 {t}_{inj}}{2} \geq t \geq \frac{{t}_{m}}{2} ) & \\ {C}_{c} = \frac{{C}_{0}}{2} \frac{{t}_{inj}}{{t}^{2}} [ {t}_{m} + 2 {t}_{inj} ] : ( t \geq \frac{{t}_{m} + 2 {t}_{inj}}{2} ) & ( Eq . 3 )\end{matrix}$$

where tᵢₙⱼ is the time over which the solute was injected into the capillary and tₘ is the mean measurement time which is equivalent to the time it would take a particle travelling at the average flow speed to arrive at the measurement point. The second term of the expression describes the steep rise in the profile when molecules travelling along the central streamline at twice the average flow speed arrive at the measurement point whilst the third term describes the long tail observed subsequent to the rise. Both these features are observable in FIG. 3, which shows a Taylorgram for a solute undergoing pure convection (with the parameters C₀=50, tₘ=4, tᵢₙⱼ=0.5).

From Eq. 3, the peak amplitude A of the front is given by

$$A = {C}_{0} \frac{2 {t}_{inj}}{{t}_{m} + 2 {t}_{inj}} \qquad ( Eq . 4 )$$

Defining the time of first arrival of the solute as

$${t}_{a} = \frac{{t}_{m}}{2} ,$$

Eq. 4 can be rewritten as

$$A = {C}_{0} \frac{{t}_{inj}}{{t}_{a} + {t}_{inj}} \qquad ( Eq . 5 )$$

Hence, the absorbance corresponding to the initial concentration of the solute can be deduced from the measured peak amplitude as shown in Eq. 6

$${C}_{0} = A \frac{{t}_{a} + {t}_{inj}}{{t}_{inj}} \qquad ( Eq . 6 )$$

Likewise, the ratio h of the peak amplitudes A₁ and A₂ measured at two measurement points labelled (1) and (2) respectively is given by

$$h = \frac{{A}_{2}}{{A}_{1}} = \frac{{t}_{a , 1} + {t}_{inj}}{{t}_{a , 2} + {t}_{inj}} \qquad ( Eq . 7 )$$

where t_{a,1} and t_{a,2} are the corresponding times of first arrival of the solute at the measuring position for the first residence time and the second residence time. For embodiments comprising a first and second measuring position (i.e. where a single injection of solute and two detectors are used), Eq. 7 can be re-written in terms of the respective distances l₁ and l₂ from the injection point to give

$$h = \frac{{A}_{2}}{{A}_{1}} = \frac{{l}_{1} + {l}_{inj}}{{l}_{2} + {l}_{inj}} \qquad ( Eq . 8 )$$

where lᵢₙⱼ is the length of the injected solute in the capillary. Hence for a given injection length and fixed measurement points, the ratio h is a constant if the solute undergoes pure convection.

Thus Eq.8 can be used to calculate h at step 201, which can be used to determine the diffusion coefficient of the solute at step 202.

FIG. 4 shows an alternative embodiment of the step 106 of method 100. In this embodiment, the ratio h for a pure convection regime is calculated as above at step 401. At step 402, the proportion f of the solute that dispersed between the first measuring point and the second measuring point is calculated. At step 403, the diffusion coefficient of the solute is determined from this proportion f.

Equation 8 describes the ratio of Taylorgram front peak heights that would be expected from a pure convection regime, where the solute does not disperse. In reality, the solute will undergo some dispersion at early times before becoming fully dispersed at times from which the dimensionless residence time τₘ>1.4. This early time dispersion will affect the actual front peak heights measured in an experiment, allowing information about the amount of dispersion, and hence the diffusion coefficient, to be extracted.

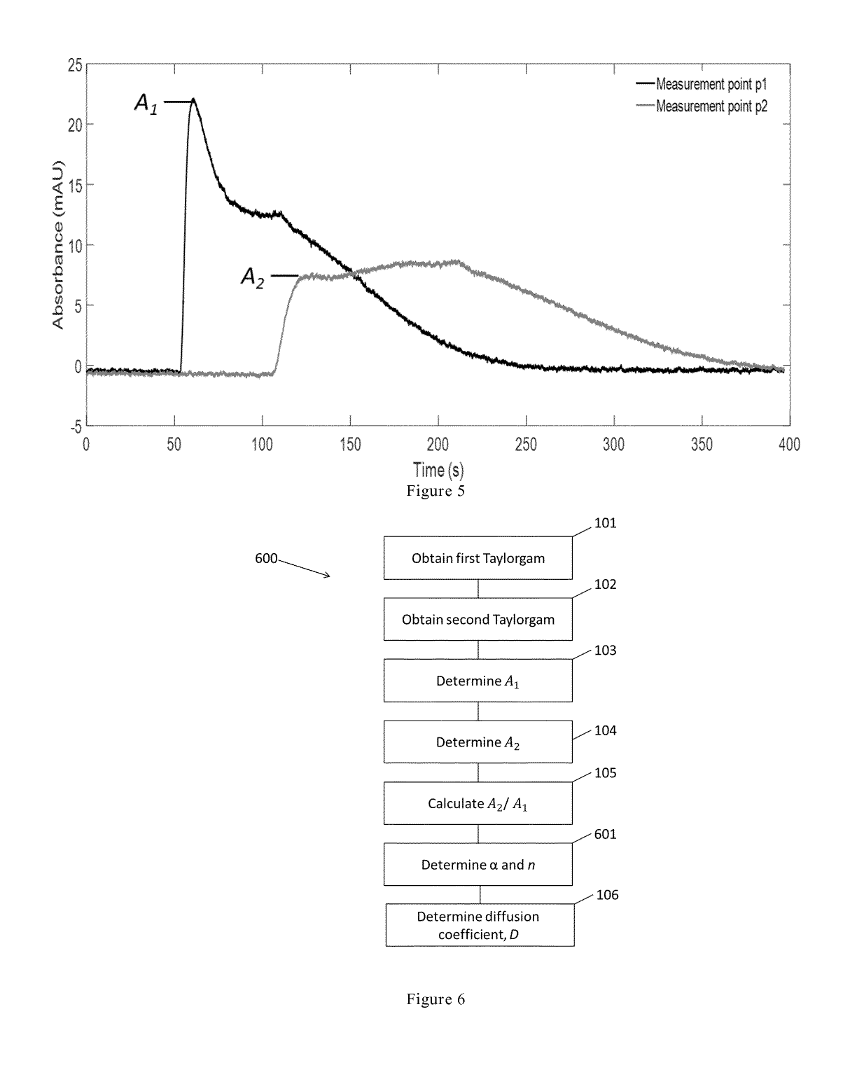

FIG. 5 shows examples of a first 501 and second 502 early-time Taylorgram (i.e. before a full dispersion condition is met) obtained from two measurement points along a capillary. The solute was nanospheres of 100 nm hydrodynamic radius in 0.01M NaCl, injected at a pressure of 500 mbar. The broad peaks observed after the initial fronts at t˜2tₐ indicate that some solute dispersion has occurred behind the front and, as expected, this is more pronounced at measurement point (2) which is further away from the injection point.

Furthermore, the amplitudes A₁ and A₂ of the fronts are reduced in comparison to the values expected for pure convection. However, using Eq. 6, it is possible to estimate how much of the injected solute is convected C_{c} from

$${C}_{n} = {A}_{n} \frac{{t}_{a , n} + {t}_{inj}}{{t}_{inj}} \qquad ( Eq . 9 )$$

where n=1, 2.

Due to the increased dispersion with time, C₂<C₁ and the difference C₁−C₂ is an estimate of the amount of solute that has dispersed upon travelling from measurement point (1) to (2). Expressing this as a fraction of C₁ gives the proportion f of the dispersed component as:

$$f = \frac{{C}_{1} - {C}_{2}}{{C}_{1}} = 1 - ( \frac{{A}_{2}}{{A}_{1}} ) ( \frac{{t}_{a , 2} + {t}_{inj}}{{t}_{a , 1} + {t}_{inj}} ) = 1 - \frac{{A}_{2}}{{hA}_{1}} \qquad ( Eq . 10 )$$

Hence f is a measure of the degree of dispersion undergone by the solute which is equal to 1 for full dispersion (when A₂=0) and equal to 0 for pure convection (when A₂=hA₁).

As mentioned earlier, the dimensionless residence time τₘ is another measure of the degree of solute dispersion (proportional to the diffusion coefficient D, as defined in Eq. (1)) and therefore a correlation between τₘ and f is expected. Assuming a power-law relationship between the two quantities, this may be expressed as:

τₘ=afⁿ (Eq. 11)

where a and n are constants to be determined for a particular set of measurement conditions. Note that when f=1 and the solute is fully dispersed, τₘ>a is otherwise the condition for full dispersion and hence a is expected to be of the order of 1.

Furthermore since τₘ is approximately equal to the average number of times a particle diffuses across the capillary radius during the time of measurement, it is therefore a measure of the average dispersion distance of the solute molecules which may be assumed to be proportional to the fraction of the solute molecules that are fully dispersed. Hence, the constant n is expected to be approximately equal to 1.

The mean dimensionless residence time τₘ is related to the hydrodynamic radius Rₕ by the well-known Stokes-Einstein relation:

$${R}_{h} = \frac{{k}_{B} T}{6 πη D} \qquad ( Eq . 12 )$$

where Rₕ is the hydrodynamic radius, D is the diffusion coefficient, k_{B} is Boltzmann's constant, T is the temperature and η is the viscosity of the carrier solution. Using this well-known relationship, the diffusion coefficient in Eq. 1 can be substituted for an expression written in terms of hydrodynamic radius Rₕ:

$${τ}_{m} = \frac{{k}_{B} T}{6 πη {R}_{h}} \frac{{t}_{m}}{{r}_{c}^{2}} \qquad ( Eq . 13 )$$

Once τₘ is known, it is therefore trivial to determine the hydrodynamic radius Rₕ. Hence the hydrodynamic radius may be directly determined in some embodiments without first determining the diffusion co-efficient D.

For the experimental measurements given herein by way of example (described later), a was determined to be 3.81, and n determined to be 1. As shown in FIG. 6, a method 600 may comprise all of the steps 101-106 of method 100, with the additional step 601 of determining the values of a and/or n. Step 601 may include obtaining Taylorgrams for samples of known diffusion coefficient or hydrodynamic radius, and extracting values of a and/or n, for example by following the methodology described in the results section below.

Therefore, Eq. 11 can be used in step 403 to determine the diffusion coefficient D using the proportion of solute that dispersed between two points, which in turn can be calculated using the amplitudes of the fronts of Taylorgrams measured at two positions along a capillary.

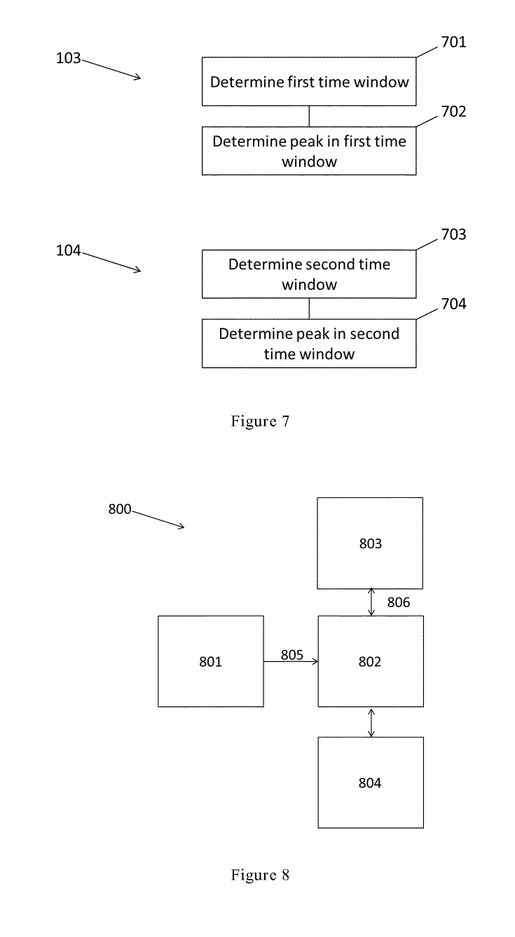

FIG. 7 shows an alternative embodiment of the steps 103, 104 of determining the front amplitudes A₁ and A₂ from the first and second Taylorgrams respectively. In some Taylorgrams, the maximum amplitude of the whole measured Taylorgram may not correspond to the solute front. This is the case, for example, in the Taylorgram shown in FIG. 5 measured at point 2. The peak at ˜200 s is larger than the amplitude of the front, due to the effects of dispersion of the solute.

In order to identify the correct time and amplitude that corresponds to the solute front, step 103 may comprise the step 701 of determining a first time window during which a solute front is expected to reach the first measuring position, and the step 702 of determining the peak amplitude of the first Taylorgram in the first time window.

Similarly, step 104 may comprise the step 703 of determining a second time window during which a solute front is expected to reach the second measuring position, and the step 702 of determining the peak amplitude of the second Taylorgram in the second time window.

The first and second time windows may be calculated for example by considering the pressure or velocity at which the solute was injected into the capillary, and the viscosity of the solution.

This disclosure describes a dispersion solution which is applicable at all dispersion times and has been used to extract the diffusion coefficients from early-time dispersion Taylorgrams. Determinations of diffusion coefficients with this approach may be particularly advantageous in situations where large particles constitute all or part of the sample. This case can be exemplified by any sample containing aggregated material, such as a biotherapeutic drug formulation. In these cases, measurement times in the order of hours would be required to ensure the dispersive regime is achieved for all solute components to allow traditional TDA. In addition, since the size of the aggregated particles is typically unknown, the run conditions required to achieve full dispersion for all components is also unknown, so data from multiple measurements with varying run conditions may need to be acquired. Using a method according to an embodiment may result in a practical measurement time (in the order of minutes), since full dispersion of all solute components is not required, and both convective components (i.e. those which are not fully dispersed) and dispersive components (i.e. those solute components which are fully dispersed) can be analysed simultaneously. The convective components may be analysed according to the method disclosed herein, and the dispersive components analysed using conventional Taylor Dispersion Analysis techniques, which are applicable to fully dispersed solute components. The need for prior knowledge of sample components and, in turn, the need the need for fine-tuning run conditions in order to generate the appropriate data may also eliminated. Furthermore, methods according to an embodiment can be used to extracts information on the concentration of the convective component, as well as the dispersive component. This is advantageous over other orthogonal techniques, such as SEC or DLS, for which: only qualitative data may be available, insufficient resolution between components may exist, larger components may be excluded from the measurement or sample modification may be required.

Methods in accordance with an embodiment can also provide faster characterisation of particles of any size provided that a reliable convective regime can be established. This may be particularly beneficial for reducing measurement times and increasing throughput for screening applications.

In cases where the signal response is limited by the amount of material available, for example by low sample concentrations, small injected volumes or by a low extinction coefficients; the proposed method would allow analyses of data acquired at earlier detection points where signal responses are generally greater and, more importantly, where sufficient signal is retained to make analyses possible. Applications that would benefit from this include characterization of eluents from a nano-LC column or other separation mechanism, whose signal may not be detected if fully dispersed due to peak broadening into the baseline noise.

### Apparatus

Referring to FIG. 8, an apparatus 800 is shown in accordance with an embodiment. The apparatus 800 comprises an instrument 801, processor 802, output means 803 and input means 804. The instrument 801 may be operable to perform a Taylor dispersion analysis on a sample, for instance at two different points along a capillary, so as to produce Taylorgram data 805 for a first and second measurement position. Alternatively, the instrument may perform two measurements at the same measurement location, each of the two measurements corresponding with a different mean measurement time (e.g. by changing the flow speed through the capillary).

The processor 802 is configured to calculate a diffusion coefficient D (or hydrodynamic radius Rₕ) of the solute from the Taylorgram data 71, in accordance with an embodiment (for instance as described above). The processor 802 may provide an output 806 to the output means 803, which may comprise a display or printer. The output 806 may comprise values or estimates of the properties of the sample analysed by the instrument 801 for example the diffusion coefficient D, or the hydrodynamic radius of the molecules of the solute. An input means 804 may be provided for controlling the processor 802 and/or instrument 801. The input means 804 may comprise a keyboard, mouse or other suitable user interface device.

The instrument 801 may comprise a capillary linking a first and second container. Liquid is driven (e.g. at constant pressure) from the first container to the second container. The first container may contain a run (or carrier) solution so that the capillary is initially filled with the run solution. The first container may then be disconnected from the capillary, and a third container connected that contains a sample solution. The sample may be a pharmaceutical or biopharmaceutical species dissolved either in the run/carrier solution, or in a different medium. The different medium may differ from the run/carrier solution in having an excipient, e.g. a salt or a sugar, dissolved at a different concentration than in the carrier/run solution. This is may be appropriate in formulations which are designed to stabilise active drug species.

A first and second window may be spaced apart along the length of the capillary between the first and second containers. The capillary may be formed in a loop so that the first and second both window may be imaged using a single optical assembly, for instance by arranging for them to be adjacent to one another in an area imaged by the pixel array of an area imaging detector. In other embodiments, the detector may comprise a single element, rather than a pixel array.

To inject a plug of the sample into the capillary, the third container may be connected to the capillary and then disconnected after a suitable volume of the sample has been injected under pressure. The second container may be connected to the capillary when the third container is disconnected from the capillary. The detector may capture a frame sequence comprising measures of the received light intensity at the detector as the pulse of sample solution or the flow front passes the first and second window. The detector output thereby provides data on absorbance versus time: a Taylorgram. In alternative embodiments, the detector may be configured to detect the refractive properties of the solute, and thus to determine the concentration of the solute passing the measuring position.

### Example Results

Nanospheres™ 3000 Series size standards with nominal hydrodynamic radii of 30, 100, 200 and 250 nm were purchased from Fisher Scientific, Leicestershire, UK and prepared in 0.01 M NaCl (Sigma Aldrich, Suffolk, UK; note standards supplied in diameter 60, 200, 400 and 500 nm, respectively) to a final concentration of 4 drops of size standard per millilitre of NaCl. From these stock solutions, various binary mixtures were also prepared in a 50:50 (v/v) ratio. In addition, binary mixtures of nanospheres and 2.5 mg/mL Bovine Serum Albumin (BSA, Sigma Aldrich, Poole, UK; Rₕ˜3.8 nm; prepared in 0.01 M NaCl) were prepared in a 50:50 (v/v) ratio. Taylorgrams were acquired using the Viscosizer TD instrument (Malvern Instruments Ltd., Worcestershire, UK) fitted with a standard two-window uncoated capillary (ID 75 μm, OD 360 μm, Malvern Instruments Ltd, Worcestershire, UK) having dimensions l₁=0.45 m and l₂=0.85 m for the distances from the inlet to two detection windows and a total capillary length of 1.30 m. Delivery of narrow solute plugs was achieved by pressure-driven injection at 50 mbar for 12 s. From these injection conditions and the capillary dimensions, the front height ratio h for pure convection was determined from Equation 8 to be 0.53.

Elution of sample plugs was undertaken at a variety of run pressures ranging from 350 to 2000 mbar. Table 1 shows the radii of the nanospheres and the corresponding run pressures used for the measurements (with m being the total number of measurements for each row). The measurements were split into three groups as shown in the table. Group I consists of nanospheres with hydrodynamic radii of 30, 100, 200 and 250 nm run at pressures ranging from 350 to 1000 mbar. Group II consists of the nanospheres with the same radii as Group I run at pressures ranging from 1250 to 2000 mbar. Group III consists of measurements at a run pressure of 250 mbar of (a) 100 and 200 nanospheres individually, (b) a binary mixture of 100 and 200 nm nanospheres and (c) binary mixtures of 2.5 mg mL⁻¹ BSA with the 100 or 200 nm nanospheres, as well as a tertiary BSA:100:200 nm mixture.

TABLE 1
Grouped measurements

| | Solute hydrodynamic | Pressure/ | |
|---|---|---|---|
| Group | radii | mbar | m |
| I | 30 nm | 833, 1000 | 6 |
| | 100, 200, 250 nm | 350-1000 | 36 |
| II | 30 nm | 1000-3000 | 27 |
| | 100, 200, 250 nm | 1000-2000 | 16 |
| III | 100, 200, 100 + 200 nm | 250 | 15 |
| | BSA + 100 nm, | 250 | 15 |
| | BSA + 200 nm, | | |
| | BSA + (100 + 200 nm) | | |

The heights, A₁ and A₂, of the fronts were determined by subtracting the value of the baseline at the time of first arrival of the front from the measured maximum front amplitude value. The correlation between f and τₘ was determined from Groups I and II. This correlation was used to make predictions for the measurements in Group III and the results compared with the expected values.

Correlation from Group I

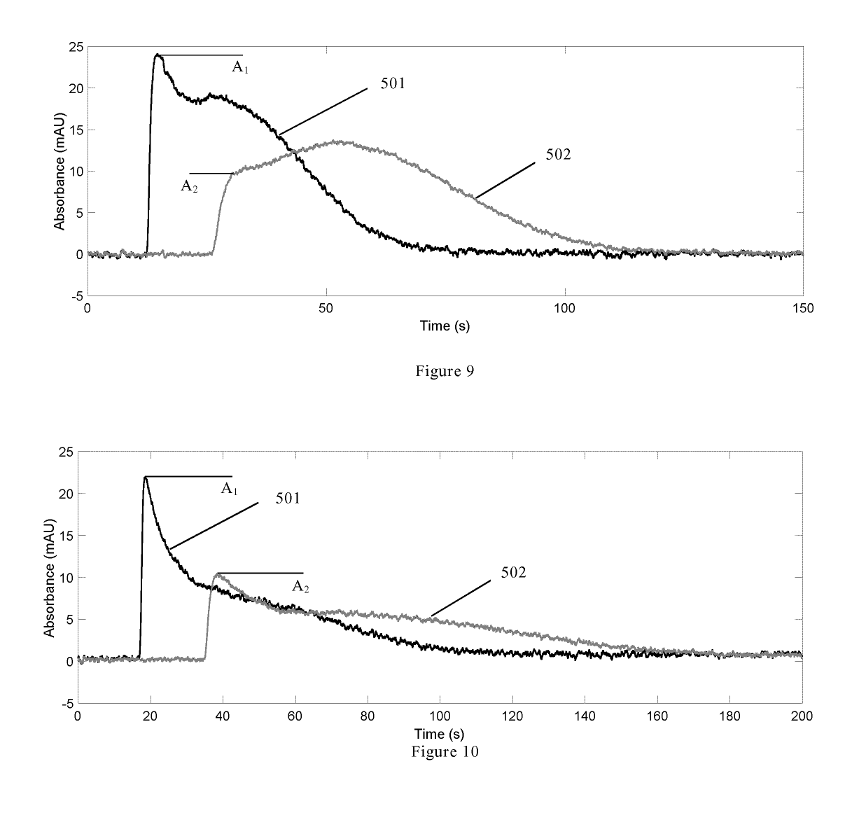

FIGS. 9 and 10 show examples of the Taylorgrams obtained from the measurements in Group I. FIG. 9 shows a first 501 and second 502 Taylorgram obtained for 30 nm nanospheres in NaCl at a run pressure of 1000 mbar. FIG. 10 shows a first 501 and second 502 Taylorgram obtained for 100 nm nanospheres in NaCl at a run pressure of 750 mbar.

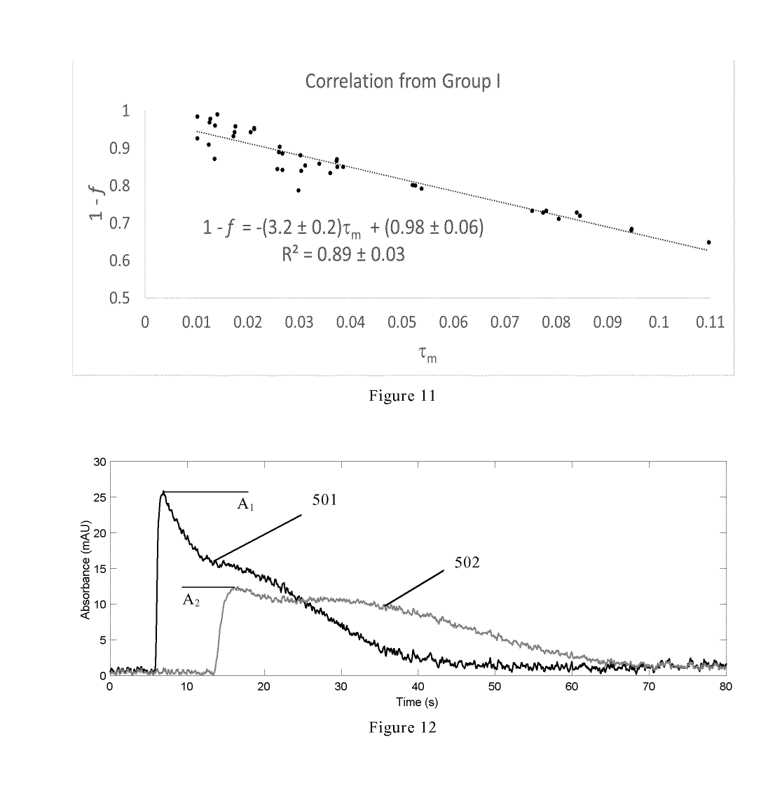

FIG. 11 shows a plot of (1-f) against τₘ for these Group I measurements. An approximately linear relationship is observed between these two variables and the equation for the regression line is shown on the plot as well as the corresponding value for the goodness of fit R². These measurements therefore imply a value of 1 for n and 3.2 for a in Eq. 11.

Correlation from Group II

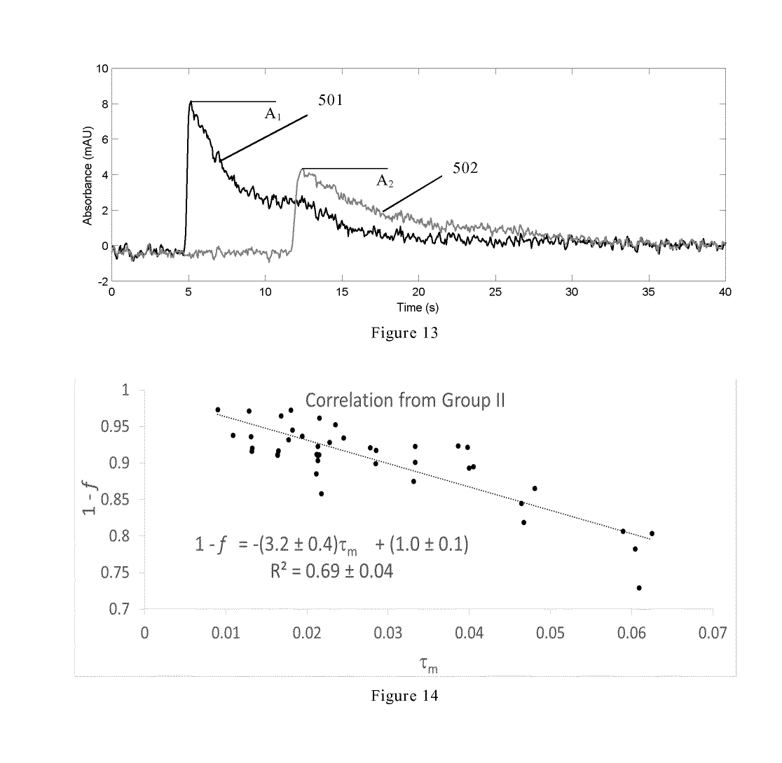

FIGS. 12 and 13 show examples of the Taylorgrams obtained from the measurements in Group II. FIG. 12 shows a first 501 and second 502 Taylorgram for 30 nm nanospheres in NaCl at a run pressure of 1750 mbar. FIG. 13 shows a first 501 and second 502 Taylorgram for 200 nm nanospheres in NaCl at a run pressure of 2000 mbar.

FIG. 14 shows a plot of (1-f) against τₘ. The equation for the regression line is shown as well as the goodness of fit which imply a value of 1 for n and 3.2 for a in Eq. 11.

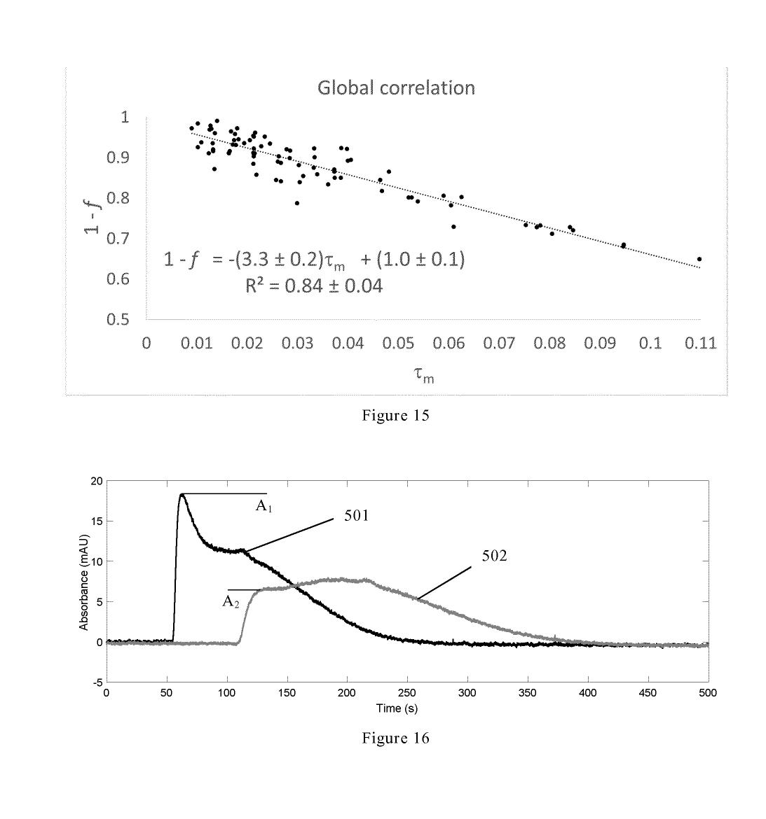

There is a good agreement between the correlations obtained from the two groups. A global fit of Groups I and II is shown in FIG. 15 as well as the equation for the regression line. This gives a value of 3.3 for a.

### Estimates for Group III

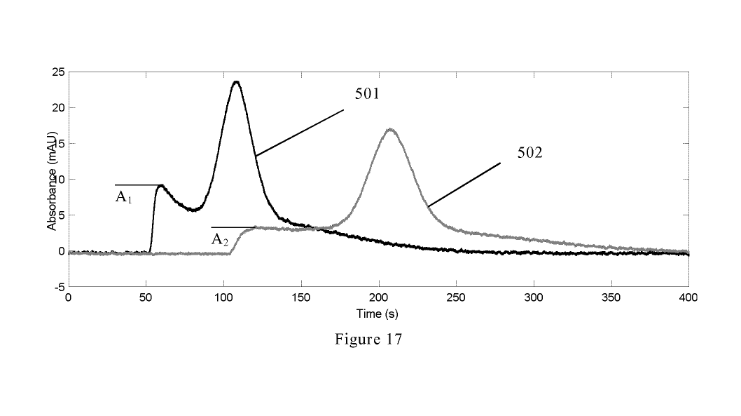

FIGS. 16 and 17 show examples of Taylorgrams obtained from the measurements in Group III. FIG. 16 shows a first 501 and second 502 Taylorgram obtained for 100 nm nanospheres in 0.01 M NaCl at a run pressure of 250 mbar. FIG. 17 shows a first 501 and second 502 Taylorgram for BSA+(100+200) nm nanospheres in NaCl at a run pressure of 250 mbar.

The equation for the regression line from the global fit to Groups I and II was used to estimate τₘ and hence the hydrodynamic radii Rₕ from the diffusion coefficients D. The results from the correlation are compared to the expected values in Table 2. Note that the expected values for the mean radii of the mixtures have been determined by weighting the radii of the two components by the relative heights of the fronts observed for the individual measurements.

TABLE 2
Expected hydrodynamic radii Rₕ from the correlation

| | Expected | Estimated |
|---|---|---|
| Measurement | Rₕ/nm | Rₕ/nm |
| 100 nm | 100 | 99 ± 3 |
| 200 nm | 200 | 197 ± 18 |
| 100 + 200 nm | 140 | 143 ± 5 |
| BSA + 100 nm | 100 | 106 ± 5 |
| BSA + 200 nm | 200 | 203 ± 27 |
| BSA + (100 + 200 nm) | 140 | 123 ± 15 |

As can be seen from Table 2, reasonable estimates are obtained for the hydrodynamic radii of the nanospheres both in isolation and in the presence of fully dispersed BSA molecules. This is expected since the heights of the fronts are used in the analysis and the contribution of the BSA molecules at these early times is negligible. The hydrodynamic radii of BSA was determined from the convective-dispersive fits described in the literature, and found to be 4.3+/−0.5 nm. This is higher than the expected value of 3.8 nm because the nanospheres also contribute to the dispersed peaks.

Other embodiments are intentionally within the scope of the invention as defined by the appended claims.

1. An apparatus comprising a processor for determining a diffusion coefficient or hydrodynamic radius of a solute in a solution flowing in a capillary, the apparatus configured to:
obtain a first signal, the first signal being proportional to the concentration of molecules in each cross-section of flow past a concentration detector and corresponding to a temporally-resolved distribution of molecular concentration, the first signal comprising a plurality of measurements of solute concentration measured at a first measurement location corresponding with a first mean measurement time that is before a full dispersion condition is met;
obtain a second signal, the second signal being proportional to the concentration of molecules in each cross-section of flow past a concentration detector and corresponding to a temporally-resolved distribution of molecular concentration, the second signal comprising a plurality of measurements of solute concentration measured at a second measurement location corresponding with a second mean measurement time that is after the first mean measurement time and before a full dispersion condition is met;
determine a first front amplitude A₁ of a solute front from the first signal, the first front amplitude corresponding to the arrival of molecules travelling at or near a central streamline at the first measurement location;
determine a second front amplitude A₂ of a solute front from the second signal, the second front amplitude corresponding to the arrival of molecules travelling at or near a central streamline at the second measurement location;
calculate: an actual front height ratio A₂/A₁ of the second front amplitude A₂ to the first front amplitude A₁; a convection front height ratio h expected for a pure convection regime; and a proportion f of the solute that dispersed between the first mean measurement time and the second mean measurement time, the proportion f calculated using the actual front height ratio A₂/A₁ and the convection front height ratio h;
derive a value of the diffusion coefficient of the solute from a relationship between the proportion f and the diffusion coefficient or hydrodynamic radius, the relationship corresponding with a particular set of measurement conditions of the first and second signal.

2. The apparatus of claim 1, wherein the first measurement location is at a first distance l₁ along the capillary from an injection location of the solute, the second measurement location is at a second distance l₂ along the capillary from the injection location of the solute.

3. The apparatus of claim 2, wherein the convection front height ratio h is calculated from the distance l₁ between the first measurement location and a point of injection of the solute into the capillary, the distance l₂ between the second measurement location and the point of injection of the solute into the capillary, and the initial length lᵢₙⱼ of the solute injected into the capillary.

4. The apparatus of claim 1, wherein the first measurement location is at the same position along the capillary as the second measurement location, using the same detector, and the difference between the first mean measurement time and the second mean measurement time is as a result of a difference in the speed with which the solution flows through the capillary during measurement of the first and second signal.

5. The apparatus of claim 4, wherein the convection front height ratio h is calculated from the time t_{a,1} of arrival of the solute at the first measurement location for the first signal and the time t_{a,2} of arrival of the solute at the second measurement location for the second signal, and the time tᵢₙⱼ over which the solute was injected into the capillary.

6. The apparatus of claim 1, wherein determining the first front amplitude comprises:
determining a first time window during which a solute front is expected to reach the first measurement location; and
determining the maximum front amplitude of the first Taylorgram in the first time window; and
wherein determining the second front amplitude comprises:
determining a second time window during which a solute front is expected to reach the second measurement location; and
determining the maximum front amplitude of the second Taylorgram in the second time window.

7. The apparatus of claim 6, wherein the first time window or the second time window is determined using the pressure at which the solute was injected into the capillary and the viscosity of the solution.

8. The apparatus of claim 4, wherein the apparatus is further configured to determine the relationship between a diffusion coefficient or hydrodynamic radius and the proportion f of a test sample of known diffusion coefficient.

9. The apparatus of claim 1, wherein the apparatus is further configured to calculate a hydrodynamic radius of molecules of the solute from the calculated diffusion coefficient.

10. The apparatus of claim 1, further comprising an instrument for performing a Taylor dispersion analysis, so as to obtain the first and second signal by measurement.

11. The apparatus of claim 10, further comprising: a pump; a capillary; a light source; a first detector and a second detector, wherein:
the pump is configured to cause fluid flow in the capillary;
the capillary comprises a first window region, adjacent the first detector, and a second window region, adjacent the second detector;
the light source is configured to illuminate the first and second detector through interior of the capillary at the first and second respective window regions; and
the first and second detectors are configured to detect the absorbance of fluid in the capillary at the respective first and second windows.

12. A method of measuring a diffusion coefficient or hydrodynamic radius of a solute in a solution flowing in a capillary, comprising:
providing a solution flowing in a capillary;
providing a first detector at a first measurement location and a second detector at a second measurement location;
injecting a solute at a pressure into the capillary;
detecting a measure of the concentration of the solute at the first measurement location using the first detector;
detecting a measure of the concentration of the solute at the second measurement location using the second detector; and
determining a diffusion coefficient of the solute using the apparatus of any of claims 1 to 9, the first signal obtained from the step of detecting using the first detector and the second signal obtained from the step of detecting using the second detector.

13. The method of claim 12, wherein the measure of concentration of the solute detected by the first and/or second detectors is the absorption of light of the solute or refractive properties of the solute.

14. The method of claim 12, wherein the solute is injected into the capillary as a slug of solute or as a pulse of solute.
